(19) United States
(12) Patent Application Publication
(10) Pub. No.: US 2004/0035472 A1
(43) Pub. Date: Feb. 26, 2004

(54) Valve arrangement having electromagnetic actuation

(76) Inventors: Rainer Teltscher, Waakirchen (DE); Erich Dorfler, Landsberg-Erpfting (DE); Gunter Meier, Ingenried (DE)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/408,775

(22) Filed: Apr. 8, 2003

(30) Foreign Application Priority Data
Apr. 8, 2002 (AT) A 539/2002

(51) Int. Cl. F15B 13/044

(52) U.S. Cl. 137/596.17

(57) ABSTRACT

A valve arrangement having electromagnetic actuation and valve elements that can be displaced by the effect of a solenoid acting against the force of a closing spring whereby the valve elements close in a sealing manner or open between valve seats of varying cross sections provided between the delivery passage and the discharge port. The first valve element (4) cooperates with a valve seat (3) having a large cross section and the first valve element (4) is provided with a passage (6) in the space upstream from the first valve seat (3) to a second valve seat (7) of smaller cross-sectional dimension whereby the second valve seat (7) cooperates with the second valve element (8) so that actuation can be simplified at reduced size and control of the valve elements can be designed in a simpler manner to be less susceptible to malfunctioning.

### BACKGROUND OF THE INVENTION

1. Field of the Invention

The invention relates to a valve arrangement having electromagnetic actuation and valve elements that can be displaced by the effect of a solenoid acting against the force of a closing spring, whereby the valve elements close in a sealing manner or open between valve seats of varying cross sections provided between the delivery passage and the discharge port.

2. The Prior Art

Valve arrangements of the noted type are known for a variety of applications. For example, WO 88/10376 describes a clutch assembly for motor vehicles wherein actuation of the clutch occurs by means of auxiliary power. Two respective solenoid valves with different opening cross sections are provided for engaging and disengaging the clutch to proportionally control the auxiliary power in relation to the force applied to the clutch pedal.

Similar valve arrangement are also used in modern gas-heating systems.

The object of the present invention is to provide a valve arrangement whereby its size is reduced and/or whereby actuation can be additionally simplified so that control of the valve elements is simpler as well and whereby the design is less susceptible to malfunctioning.

### SUMMARY OF THE INVENTION

For the achievement of this object, according to the invention the first valve element cooperates with a valve seat having a large cross section and there is provided a passage in the space upstream from the first valve seat to a second valve seat having a smaller cross section, and the second valve seat cooperates with the second valve element.

According to a preferred embodiment of the invention, at least the first valve element is designed as a solid component which has only a passage inserted leading from the first valve seat to the second valve seat and which is biased at the outside by a closing spring. This results in an optimal conduit of magnetic flow and achieved are thereby more favorable force conditions at the first valve element.

It is advantageously proposed that the second valve element is arranged behind the first valve element in longitudinal direction and that the passage runs through the first valve element preferably in an essentially straight line. The second valve element cooperates in its completely closed position together with the first valve element in the closing direction so that this closed position may be maintained securely also against high pressure. The straight flow through the valve elements offers an improved flow characteristic within the relative lengthy passageway between the valve seats.

The second valve seat is thereby advantageously formed on the first valve element itself.

For the purpose of also optimizing the force conditions for the valve part having smaller cross-sectional dimensions, in an additional advantageous embodiment the second valve element is also designed as a solid component that is biased by the closing spring preferably at its outer side.

Both valve seats and valve elements are preferably arranged in the same valve housing for the purpose of simple design and considerable space savings.

According to a preferred embodiment of the invention, both closing springs are mounted in a supporting manner and independently from one another on the housing of the valve arrangement.

It is preferably proposed that the closing spring biasing the second valve element exerts less force than the closing spring biasing the first valve element to make proportional control easier and to guarantee proper sequence in actuation of the valve parts.

According to an advantageous embodiment of the invention, the valve housing is provided with a ventilation boring that is connected to the discharge port of the valve in the closed position of both valve elements whereby the ventilation boring can be closed by the second valve element at the end of its valve stroke.

The ventilation boring is thereby preferably disposed at the side opposite the second valve seat of the second valve element whereby the ventilation boring can be closed by the side (of the valve element) opposite the second valve seat of the second valve element.

According to another embodiment, the inventive valve arrangement is characterized in that the valve housing is provided with a delivery passage that can be connected to a pressure medium source whereby the delivery passage is connected to a servo discharge port of the valve in the closed position of both valve elements, whereby the delivery passage can be closed by the second valve element at the end of a valve stroke and whereby a connection is established at the same time from the delivery passage to the connection of the consuming device.

Simple construction is possible in the type of design described in the above paragraph whereby the connection between the delivery passage and the connection of the consuming device is advantageously formed by a boring machined in the second valve element whereby the boring ends at the side facing the first valve element outside the area of the second valve seat.

It is proposed that the valve elements themselves consist mainly or preferably in total of a material that can be magnetized to simplify manufacturing of the valve elements and to simplify the entire design through a decrease of necessary components.

The invention will be described in more detail in the following description with the aid of the attached drawings.

### BRIEF DESCRIPTION OF THE DRAWINGS

FIG. 1 is a schematic view of a valve arrangement according to a first embodiment of the present invention; and

FIG. 2. is a schematic view of a second embodiment of valve arrangement according to the invention.

### DETAILED DESCRIPTION OF THE PREFERRED EMBODIMENTS

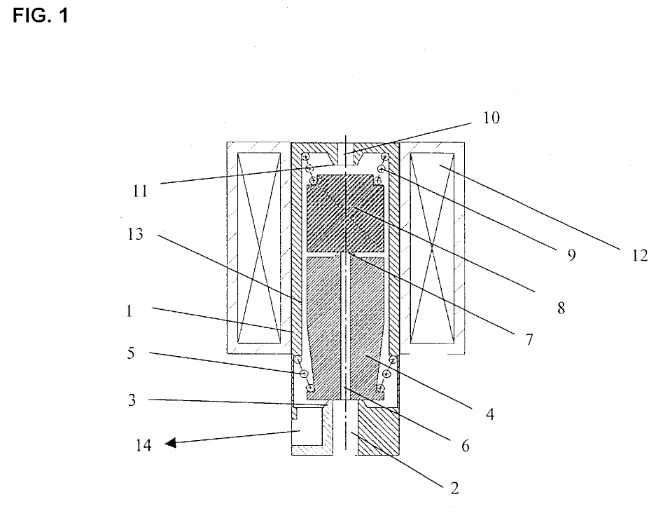

In FIG. 1, a delivery passage 2 is provided in a valve housing 1 through which the existing compressed air reaches a first valve seat 3. This first valve seat 3 with large cross-sectional dimensions is kept closed or open through a first valve element in the form of a preferably solid main plunger 4, which is biased by a first closing spring 5 surrounding the same and which plunger 4 makes contact with the valve seat 3 with a high closing force.

However, in the main plunger 4 there is a passage provided for the in-flowing compressed air from the space in front of the first valve seat 3 to a space behind the main plunger 4 in the form of an advantageously and essentially straight-running boring 6 in the otherwise solid main plunger 4. The boring 6 reaches up to a second valve seat 7 at the bottom end of the main plunger 4 that is opposite the valve seat 3 and whereby the second valve seat 7 has a smaller cross section than the first valve seat 3.

The second valve seat 7 is kept open or closed by a second valve element disposed in the housing 1 in the form of an auxiliary plunger 8 arranged behind the main plunger 4 in longitudinal direction, whereby a closing spring 9 exerts a smaller force onto this auxiliary plunger 6 than the closing spring 5, and whereby the auxiliary plunger 6 is also designed advantageously in a solid manner. The closing spring 5 is mounted in a supporting way only on the housing 1 of the valve arrangement, just like the closing spring 9 but independent thereof. A ventilation opening 10 is additionally provided in the housing 1, according to the illustrated embodiment, which leads to a third valve seat 11 inside the housing 1. The third valve seat 11 can be closed by the auxiliary plunger 8 when the plunger is lifted away from the second valve seat 7 against the force of the closing spring 9 and when the plunger is in the top position of its opening stroke.

For the actuation of both plungers 4, 8, a controllable solenoid 12 is provided on the outer side of the housing 1 of the valve arrangement, having a magnetic force proportional to the controlling electric current, whereby the plungers consist either totally of material that can be magnetized or contains at least a part of such material.

The compressed air, originating from a compressed air source (not illustrated), or any other medium controlled by the valve arrangement according to the invention, reaches after its release at least the second valve seat 7 through the gap 13 between the inner wall of the housing 1 and the main plunger 4, and the compressed air flows then to the discharge port 14 of the valve arrangement and continues to flow to the consuming device (also not illustrated).

The existing compressed air flows through the delivery passage 2 and continues to flow through the boring 6 in the main plunger 4 to the second valve seat 7 on the main plunger 4. The second closing spring 9 pushes the auxiliary plunger 8 onto the valve seat 7 while the solenoid is not under electric power and the closing spring 9 keeps the valve seat 7 sealed thereby and prevents therefore the flowing of compressed air through the gap 13 to the discharge port 14. The connected consuming device experiences, on the contrary, ventilation through the discharge port 14, the gap 13 and the ventilation boring 10.

Should the solenoid coil 12 now be powered by part of the maximum electrical current—which must be adjusted depending on the operational pressure of the compressed air and the strength of the closing spring 5—the auxiliary plunger 8 is pulled against the valve seat 11 of the ventilation boring 10 and it seals thereby the ventilation boring 10. The compressed air can now flow across the cross section of the boring 6, the valve seat 7 of smaller cross-sectional dimensions, onto the gap 13 and to the discharge port 14 and continue to the consuming device. Given the particular voltage in the coil 12, the auxiliary plunger 8 is again pushed onto the valve seat 7 by the effect of the closing spring 9 and air delivery to the discharge port 14 is thereby blocked—and the consuming device is ventilated at the same time.

However, should the solenoid coil be powered further by the maximum electric current—which can occur without prior opening of the valve section having a smaller cross section—then both plungers 4, 8 are finally pulled toward the anti-pole and the main plunger 4 is then also pulled away from the first valve seat 3 against the stronger closing spring 5 and the larger cross section is thereby opened up. Through the inventive arrangement it is possible therefore to use a simple arrangement, preferably even a housing having two (different) cross sections.

The above-described embodiment is designed as a 3/2-port directional control valve. A 2/2-port directional control valve design is also possible in case of a permanently sealed or by-passed ventilation boring 10.

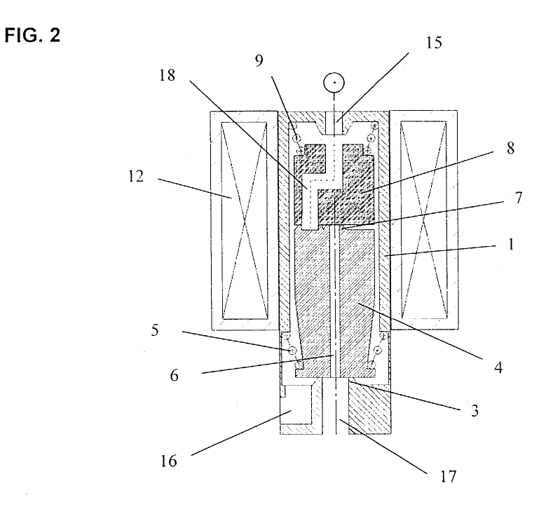

In the embodiment illustrated in FIG. 2, which has also a 3/2-port directional control valve version, the valve housing 1 can be connected to a pressure medium source whereby the delivery connection 15 for the pressure medium source is provided on the opposite side of the valve housing 1 compared to FIG. 1. In the closed position of both valve elements 4, 8 and under the effects of the two closing springs 5 and 9 (as illustrated in FIG. 2), the pressure medium delivery passage 15 is connected to the servo discharge port 16 of the valve so that a constant pressure exists at this port 16. The pressure medium connection to the consuming device, which is running through the consuming device connection 17, is closed in this (particular) position of the valve arrangement since the second valve element 8 blocks the second valve seat 7 and thereby the passage 6 as well.

Should the coil 12 be brought now under electric power, then the second valve element 8 is lifted away from the valve seat 7 against the effect of the closing spring 9 and a connection is then established at the end of its valve stroke from the delivery passage 15 to the consuming device connection 17. This connection between the delivery passage 15 and the consuming device connection 17 is preferably formed by a boring 18 machined in the second valve element 8 (as illustrated in FIG. 2) whereby the boring 18 ends at the side facing the first valve element 4 outside the area of the second valve seat 7. The connection is also established in this position of the valve arrangement with the pressure medium delivery of the servo discharge port 16 of the valve.

Only when the coil 12 comes under higher electric power, the first valve element 4 is additionally lifted away from the first valve seat 3 and blocks again the passage 18 in the second valve element 8 at the end of its valve stroke. The pressure medium delivery passage 15 is thereby blocked and the pressure medium can flow from the servo discharge port 16 to the consuming device connection 17. However, the pressure on the servo-mechanism is reduced thereby and the connected valve or similar switch element can (subsequently) switch over.

We claim:

1. A valve arrangement having electromagnetic actuation and valve elements that can be displaced by the effect of a solenoid acting against the force of a closing spring whereby said valve elements close in a sealing manner or open between valve seats of varying cross sections provided between the delivery passage and the discharge port, wherein the first valve element (4) cooperates with a valve seat (3) having a large cross section and that there is provided a passage (6) in the space upstream from the first valve seat (3) to a second valve seat (7) having a smaller cross section, and whereby the second valve seat (7) cooperates with the second valve element (8).

2. A valve arrangement according to claim 1, wherein at least the first valve element (4) is designed as a solid component which has only a passage (6) inserted leading from the first valve seat (3) to the second valve seat (7) and which is biased at the outside by a closing spring (5).

3. A valve arrangement according to claim 2, wherein the second valve element (8) is arranged behind the first valve element (4) in longitudinal direction and that said passage (6) runs through the first valve element (4) preferably in an essentially straight line.

4. A valve arrangement according to claim 3, wherein the second valve seat (7) is formed on the first valve element (4) itself.

5. A valve arrangement according to claim 2, wherein the second valve element (8) is also designed as a solid component that is biased by a closing spring (9) preferably at its outer side.

6. A valve arrangement according to claim 5, wherein both valve seats (3, 7) and valve elements (4, 8) are arranged in the same valve housing (1).

7. A valve arrangement according to claim 6, wherein both closing springs (5, 9) are mounted in a supporting manner and independently from one another on said housing of the valve arrangement.

8. A valve arrangement according to claim 7, wherein said closing spring (9) biasing the second valve element (8) exerts less force than said closing spring (5) biasing the first valve element (4).

9. A valve arrangement according to claim 8, wherein said valve housing (1) is provided with a ventilation boring (10) that is connected to the discharge port (14) of the valve in the closed position of both valve elements (4, 8) whereby said ventilation boring (10) can be closed by the second valve element (8) at the end of its valve stroke.

10. A valve arrangement according to claim 9, wherein said ventilation boring (10) is preferably disposed at the side opposite the second valve seat (7) of the second valve element (8) whereby said ventilation boring (10) can be closed by the side (of the valve element) opposite the second valve seat (7) of the second valve element (8).

11. A valve arrangement according to claim 8, wherein said valve housing (1) is provided with a delivery passage (15) that can be connected to a pressure medium source whereby said delivery passage (15) is connected to a servo discharge port (16) of the valve in the closed position of both valve elements (4, 8), whereby said delivery passage (15) can be closed by the second valve element (8) at the end of a valve stroke, and whereby a connection is established at the same time from said delivery passage (15) to the consuming device connection (17).

12. A valve arrangement according to claim 11, wherein the connection between said delivery passage (15) and said consuming device connection (17) is formed by a boring (18) machined in the second valve element (8) whereby said boring (18) ends at the side facing the first valve element (4) outside the area of the second valve seat (7).

13. A valve arrangement according to claim 12, wherein the valve elements (4, 8) themselves consist mainly of a material that can be magnetized.
